(19) United States
(12) Patent Application Publication
(10) Pub. No.: US 2014/0116810 A1
(43) Pub. Date: May 1, 2014

(54) METHOD OF ENABLING REGENERATIVE MOTOR DRIVE TO POWER AN ELEVATOR AND RECEIVE POWER FROM A RENEWABLE POWER SOURCE

(71) Applicant: Jack Vrankovic, Matawan, NJ (US)

(72) Inventor: Jack Vrankovic, Matawan, NJ (US)

(21) Appl. No.: 13/832,349

(22) Filed: Mar. 15, 2013

Related U.S. Application Data
(60) Provisional application No. 61/718,766, filed on Oct. 26, 2012.

(51) Int. Cl. B66B 1/30

(52) U.S. Cl. CPC B66B 1/302
USPC 187/290

(57) ABSTRACT

A method of running an elevator system in both passenger operation mode and a renewable energy mode. The method includes determining if a request has been received for an elevator cab to move to a specific location; determining if a request has been received to operate the elevator cab in a specific alternative mode if there are no requests for the elevator cab to move to a specific location; signaling a semiconductor switch to connect a renewable energy source to a regenerative motor drive if it is determined there are no requests received to operate the elevator cab in a specific alternative mode; and absorbing regenerative power produced by the renewable power source until the elevator control system receives a request to enter passenger operation mode. Additional processes are provided for multiple car and multiple renewable source embodiments.

### RELATED APPLICATION

This application hereby claims priority to U.S. Provisional Patent Application No. 61/718,766 filed Oct. 26, 2012, entitled “METHOD OF ENABLING REGENERATIVE SEMICONDUCTOR MOTOR DRIVE TO POWER AN ELEVATOR AND RECEIVE POWER FROM A WIND TURBINE OR SOLAR ARRAY,” the disclosure of which is incorporated herein by reference.

### BACKGROUND

The present disclosure is related to using a regenerative motor drive to power an elevator. More specifically, the present disclosure is related to providing a control system for enabling a regenerative motor drive to power an elevator while receiving power from one or more renewable energy sources.

Many companies and businesses are becoming more energy conscious as a result of increasing energy costs. Some energy providers such as utility companies provide businesses financial incentives for operating at least a portion of its business in a green mode, or an energy efficient mode. Many office devices such as printers, copy machines, and similar devices include an energy efficient mode configured to reduce the overall power consumption of those devices. However, many other aspects of a business may not incorporate similar energy reduction solutions.

For example, most multi-story business buildings have one or more elevators. In practice, an elevator is used for a small portion of the time a business is operating. However, the elevator consumes a large amount of power during normal operation, and typically does not have a low energy or green mode.

What is needed is a system and accompanying method for running one or more elevators in concert with one or more renewable energy sources such that the normal operation of the elevator remains unaffected, while the renewable energy sources provide power to a regenerative motor drive, for example, when the elevator is not operating.

### SUMMARY

In one general respect, an embodiment discloses a method of running an elevator system in both passenger operation mode and a renewable energy mode. The method includes determining if a request has been received for an elevator cab to move to a specific location; determining if a request has been received to operate the elevator cab in a specific alternative mode if there are no requests for the elevator cab to move to a specific location; signaling a semiconductor switch to connect a renewable energy source to a regenerative motor drive if it is determined there are no requests received to operate the elevator cab in a specific alternative mode; and absorbing regenerative power produced by the renewable power source until the elevator control system receives a request to enter passenger operation mode.

In another general respect, a second embodiment discloses a method of running an elevator system comprising a plurality of elevator cabs in both passenger operation mode and a renewable energy mode. The method includes determining if a request has been received for each of the plurality of elevator cabs to move to a specific location; determining if a request has been received to operate each of the plurality of elevator cabs in a specific alternative mode if there are no requests for the elevator cab to move to a specific location; signaling a semiconductor switch to connect a renewable energy source to a regenerative motor drive for each of the plurality of elevator cabs if it is determined there are no requests received to operate each of the plurality of elevator cabs in a specific alternative mode; absorbing regenerative power produced by the renewable power source until the elevator control system receives a request to enter passenger operation mode; receiving a request for at least one of the elevator cabs to move to a specific location; and determining which of the plurality of elevator cabs to move to the specific location and which to leave in regenerative mode.

### BRIEF DESCRIPTION OF THE FIGURES

FIG. 1 depicts an example of a motor drive operably connected to a renewable energy source according to an embodiment.

FIG. 2 depicts a sample elevator control layout for a building according to an embodiment.

FIG. 3 depicts a flow chart illustrating a process for mode selection according to an embodiment.

FIG. 4 depicts a flow chart illustrating a process for operating in a secondary mode including regenerating power via a renewable energy source according to an embodiment.

FIG. 5 depicts an example of a motor drive operably connected to multiple renewable energy sources according to an embodiment.

FIG. 6 depicts a flow chart illustrating a process for mode selection for a system including multiple renewable energy sources according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The present disclosure describes an elevator control technique that uses an elevator control system to determine if a regenerative motor drive should control the elevator motor or receive regenerated power from a renewable energy source such as a roof mounted wind turbine and/or a solar array.

Typically, a motor drive and control system for a building are located at or neat the roof of the building. Additional systems for the building such as HVAC, communications, and other similar systems may be placed on the roof as well. However, there is typically a lot of wasted or empty space on a building roof, space suitable for the installation of a renewable energy source such as a wind turbine or a solar array. As discussed herein, energy provided by the renewable energy source may be directed to a regenerative motor drive associated with the elevator and stored for later use, thereby reducing the overall power usage of the elevator. In some instances, the power collected by the renewable energy sources may be provided to other systems within the building (e.g., the HVAC) or transferred back to a power grid. In these instances, a power supplier such as a utility company may provide financial refunds or other incentives to the building owner or a business occupying the building.

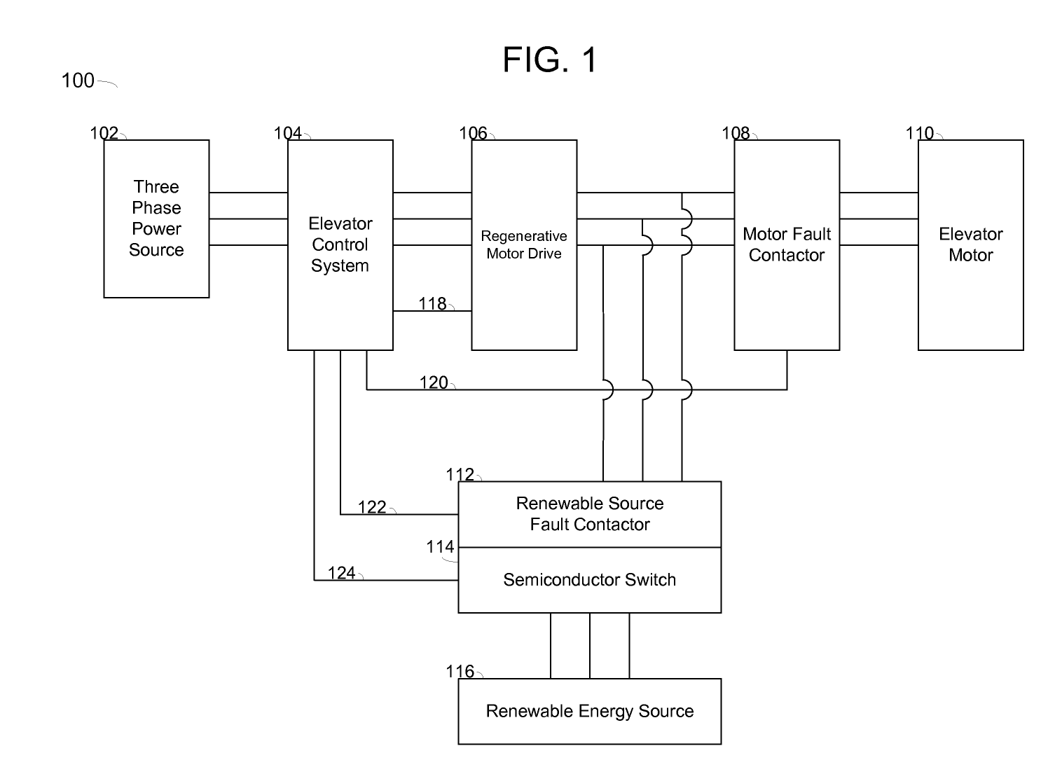

In one embodiment of the present disclosure, a geared or gearless elevator may be powered by a regenerative motor drive via a run command/speed reference from the elevator controller. A fault contactor wired in series with the motor windings may interrupt potential current flow when the elevator controller does not have a command. When the elevator control system determines that there is no demand for elevator service, it may provide a bias signal to a semiconductor switch mounted in series with a roof mounted renewable energy source. A fault contactor may be wired in series with the renewable energy source in the event that the semiconductor switch was to fail. Additional details are provided in the following discussions of FIGS. 1-6.

FIG. 1 illustrates an example of a motor drive and control assembly 100 according to an embodiment of the present invention. The assembly 100 includes a three phase power source 102 operably connected to an elevator control system 104. As shown in FIG. 1, three connections are typically shown between components, each connection representing one of the three phases. However, it should be noted that this is shown by way of example only.

The elevator control system 104 may be operably connected to a regenerative motor drive 106. The motor drive 106 may include a series of power cells (not shown in FIG. 1) for storing regenerative power created during braking or other similar power generating operations. Additionally, in accordance with the concepts of the present invention, the power cells may be configured to store power generated by one or more renewable energy sources.

The regenerative motor drive 106 may be operably connected to a motor fault contactor 108, thereby providing a safety cutoff between the motor drive and the elevator motor 110. Additionally, and in accordance with the teaching of the present disclosure, a renewable source fault contactor 112 may be connected between the motor drive 106 and the motor fault contactor 108. The renewably source fault contactor 112 may be connected in series with a semiconductor switch 114, which is in turn operably connected to one or more renewable energy sources 116. The semiconductor switch 114 and renewable source fault contactor 112 may be configured to operate as safety cutoffs to ensure that no power is incorrectly being provided to the motor drive 106 when the motor drive is not operating in regenerative mode.

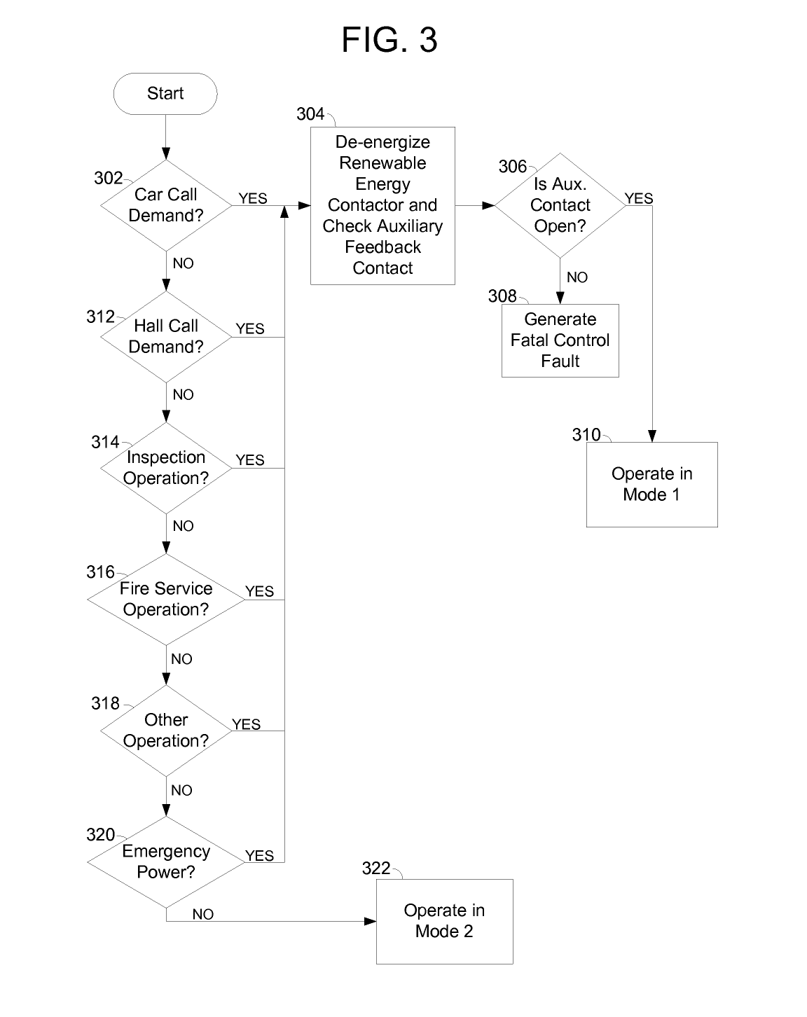

Additionally, several specific control lines may be used to send control signals between components in assembly 100. For example, speed reference and run command control line 118 may be operably connected between the elevator control system 104 and the motor drive 106. Similarly, a control line 120 for transmitting a command to energize a motor fault contactor coil may be operably connected between the elevator control system 104 and the motor fault contactor 108. A control line 122 for transmitting a command to energize a renewable source fault contactor coil may be operably connected between the elevator control system 104 and the renewable source fault contactor 112. Also, a control line 124 for transmitting a command to bias the semiconductor switch 114 may be operably connected between the elevator control system 104 and the semiconductor switch. The various control signals as discussed herein will be addressed in additional detail in the following discussions related to the processes as shown in FIGS. 3, 4 and 6.

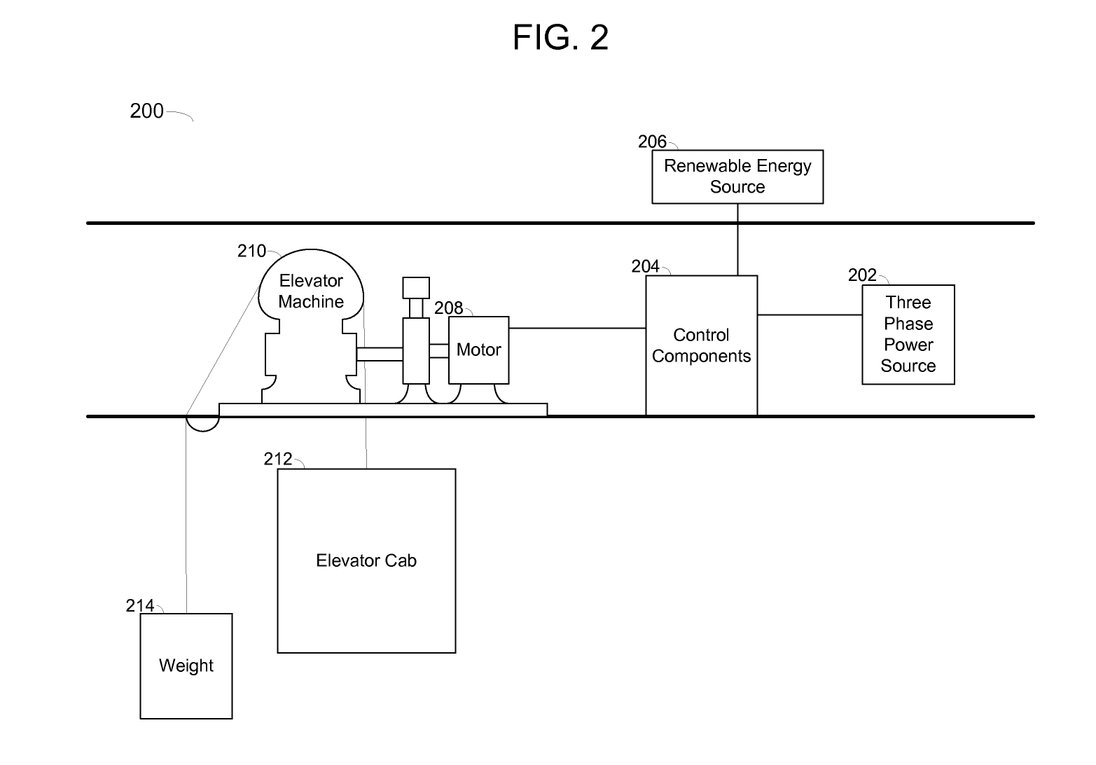

FIG. 2 illustrates a sample elevator control layout and assembly 200 for a particular building. Like assembly 100, the assembly 200 includes a three phase power source 202, various control components 204 such as the elevator control, motor drive and semiconductor switch as shown in FIG. 1, at least one renewable energy source 206, and a motor 208. Additionally, assembly 200 includes an elevator machine 210 configured to convert rotational energy produced by the motor 208 into a lifting force for an elevator cab 212. To counterbalance the elevator cab 212, and to reduce the overall weight the elevator machine 210 is required to lift, a weight 214 may be positioned such that a downward gravitational force applied to the weight provides a lifting force on the elevator cab.

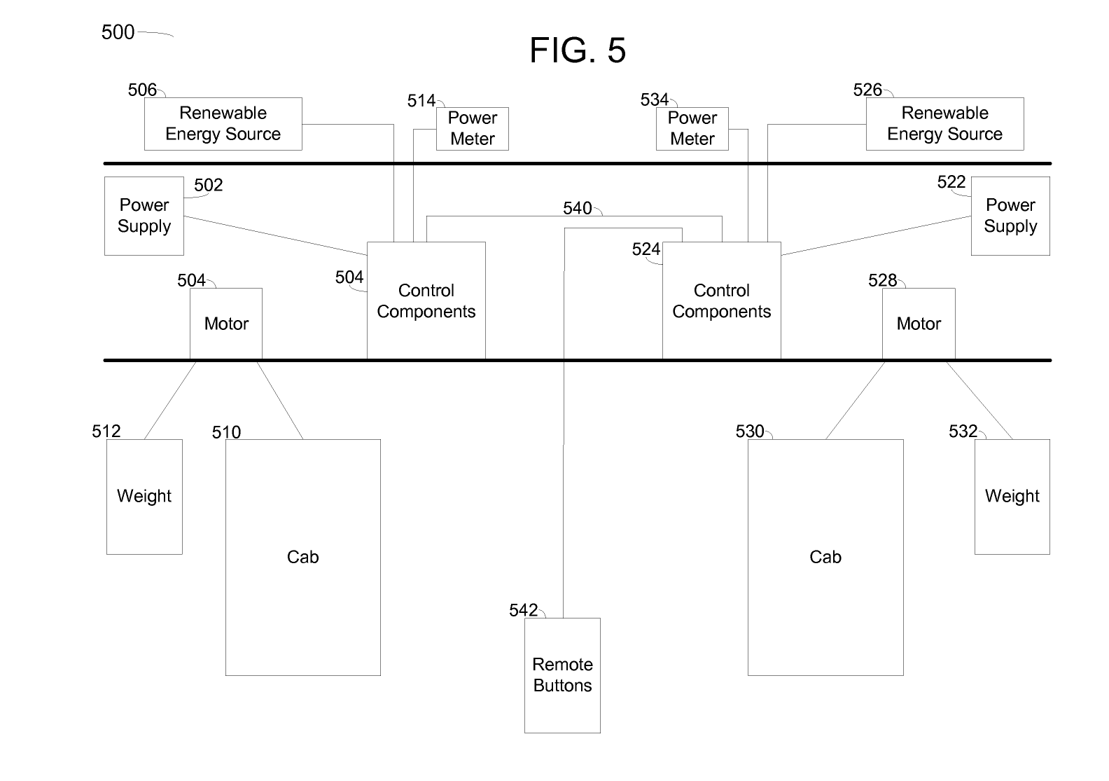

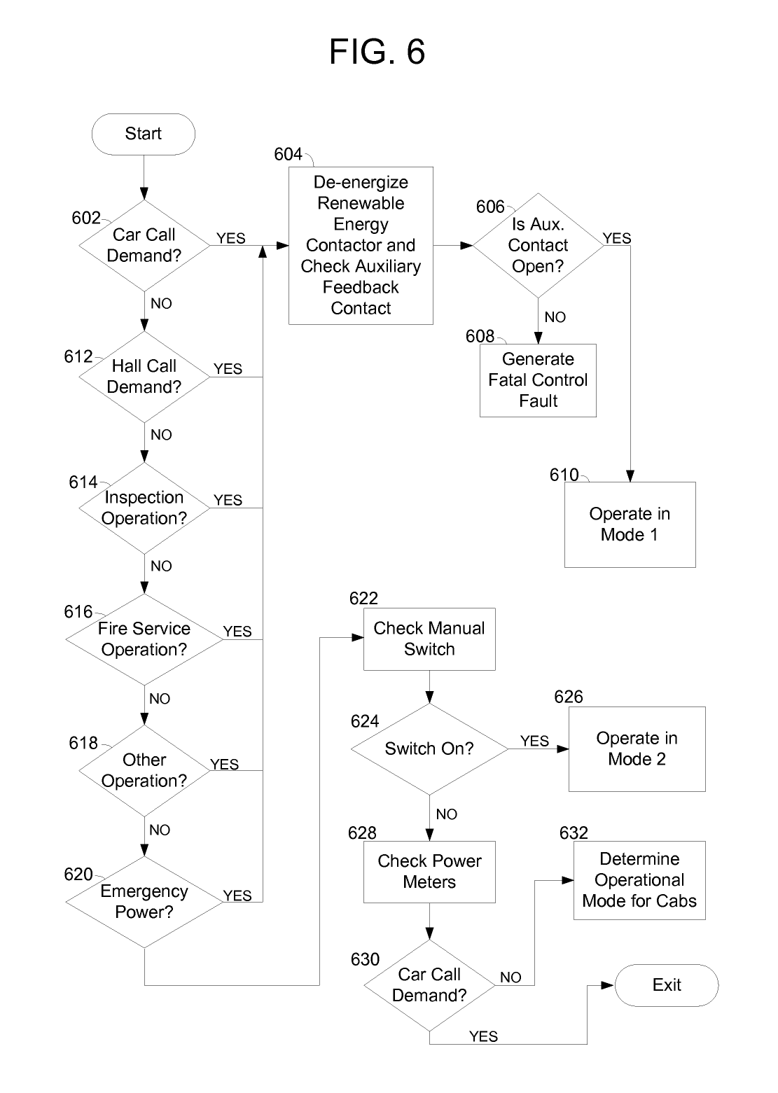

It should be noted that the building assembly as shown in FIG. 1 is shown with a single elevator cab 212 by way of example only. The ideas and techniques as disclosed herein may be applied to a multi-cab system as well. The discussions below regarding FIGS. 5 and 6 specifically address a multi-cab system.

FIG. 3 depicts a flow chart illustrating a sample process for mode selection during elevator operation. For example, an elevator system according to the present disclosure (such as assembly 200 as shown in FIG. 2) may have two main modes of operation: (1) standard elevator operation and software routines for carrying passengers; and (2) renewable power mode, where one or more renewable energy sources are used to regenerate power. The process as shown in FIG. 1 may be performed by a control device (such as elevator control system 104 as shown in FIG. 1), or another similar computer processing device.

Initially, the control system may determine 302 if there has been a car call demand. For example, has someone in an elevator cab selected a desired floor? If the control system determines 302 there has been a car call demand, the control system may de-energize 304 the renewable energy contactor and check the auxiliary feedback contact. For example, referring to FIG. 1, to de-energize 304 the renewable energy contactor, the elevator control system 104 may send a control signal via control line 124 to the semiconductor switch 114, instructing the switch to de-energize, thereby disconnecting the renewable energy source 116 from the system.

The control system may also determine 306 if the auxiliary contact is open. If the control system determines the auxiliary contact is not open, the control system may generate 308 a fatal control fault. Alternatively, if the control system determines 306 the auxiliary feedback contact is open, the elevator control system may operate 310 in mode 1, i.e., standard elevator operation and software routines.

If the control system does not determine 302 there has been a car call demand, the control system may perform a series of additional system checks and determinations. For example, as shown in FIG. 3, the control system may: determine 312 if there has been a hall call demand; determine 314 if the elevator is operating in inspection mode; determine 316 if the elevator is operating in fire service mode; determine 318 if the elevator is operating another mode such as hospital emergency mode, independent operating mode, and other similar modes; and determine 320 if the elevator is operating on emergency power. If the control system determines 312, 314, 316, 318, 320 any of the conditions in the affirmative, the control system de-energizes 304 the renewable energy contactor as before.

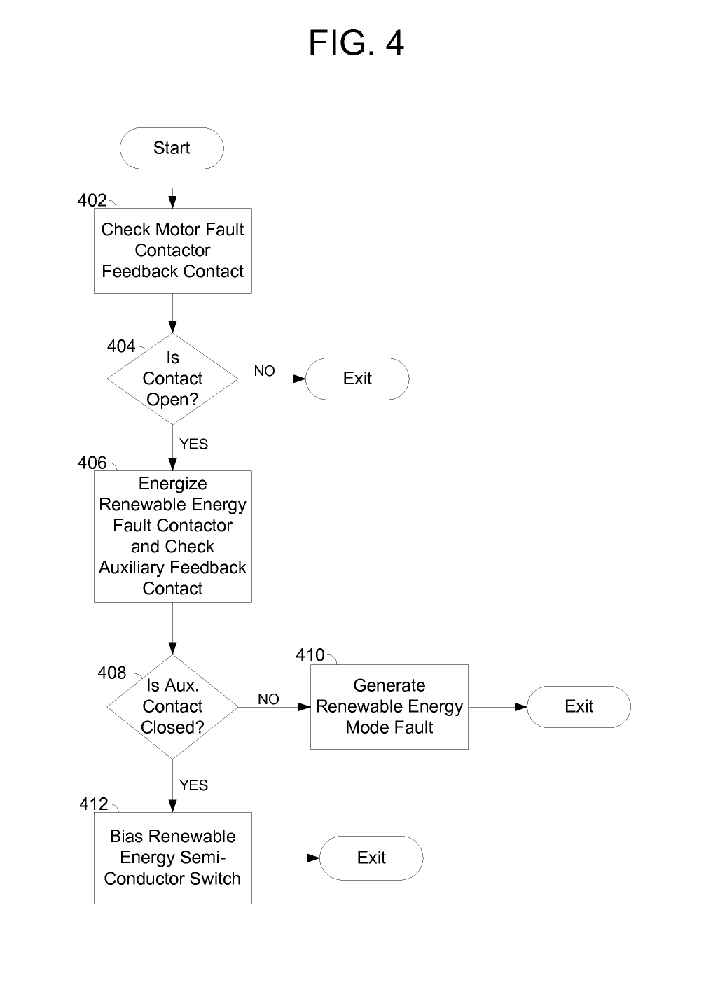

In contrast, if the control system determines 312, 314, 316, 318, 320 all to be negative, the control system may operate 322 the elevator system in mode 2, i.e., in renewable power mode, where one or more renewable energy sources are used to regenerate power. FIG. 4 depicts a flowchart illustrating a sample process for operating an elevator system in mode 2.

Initially, the control system may check 402 the motor fault contactor feedback contact. If the control system determines 404 the feedback contact is not open, the process may exit and return to the mode selection process as shown in FIG. 3. Alternatively, if the control system determines 404 that the feedback is open, the control system may energize 406 the renewable energy fault contactor, and check the auxiliary feedback contact.

If the control system determines 408 that the auxiliary contact is open, the control system may generate 410 a renewable energy mode (i.e., mode 2) fault, and the process may return to the mode selection process as shown in FIG. 3. Alternatively, if the control system determines 408 that the auxiliary contact is closed, the control system may bias 412 the renewable energy semiconductor switch, thereby energizing a coil within the switch, connecting the renewable energy source to the regenerative motor drive, allowing the motor drive to absorb regenerative power from the renewable energy source.

As described above, the system and processes as described herein may be applied to elevator systems including multiple cars, as well as systems including multiple renewable energy sources. FIG. 5 depicts an example of a motor drive assembly 500 including multiple elevator cabs and multiple renewable energy sources.

Within assembly 500, a first elevator control layout may include a three phase power source 502, various control components 504 such as the elevator control, motor drive and semiconductor switch as shown in FIG. 1, a first renewable energy source 506, and a motor 508, which may include various components such as an elevator machine (like elevator machine 210 in FIG. 2) configured to provide a lifting force for an elevator cab 510. To counterbalance the elevator cab 510, and to reduce the overall weight the motor 508 is required to lift, a weight 512 may be positioned such that a downward gravitational force applied to the weight provides a lifting force on the elevator cab 510. Additionally, a power meter 514 may be included and configured to provide an accurate measurement of the amount of power being produced by the first renewable energy source 506. For example, if the first renewable energy source 506 is a solar panel, the power meter 514 may be a solar power meter.

Additionally, within assembly 500, a second elevator control layout may include a three phase power source 522, various control components 524 such as the elevator control, motor drive and semiconductor switch as shown in FIG. 1, a second renewable energy source 526, and a motor 528, which may include various components such as an elevator machine (like elevator machine 210 in FIG. 2) configured to provide a lifting force for an elevator cab 530. To counterbalance the elevator cab 530, and to reduce the overall weight the motor 528 is required to lift, a weight 532 may be positioned such that a downward gravitational force applied to the weight provides a lifting force on the elevator cab 530. Additionally, a power meter 534 may be included and configured to provide an accurate measurement of the amount of power being produced by the second renewable energy source 526. For example, if the second renewable energy source 526 is a turbine, the power meter 534 may be an anemometer. A controller may be able to determine, based upon the reading of the anemometer, the current wind speed and the potential energy being produced by the second renewable energy source 526 (e.g., the wind turbine).

Linking both the first and second elevator control layouts may be a duplex communication line or bus 540, thereby provide duplex communication between the control components 504 and the control components 524. Additionally, a set of remote buttons 542 may be operably connected to one or both of the control components. As shown in FIG. 5, the remote buttons 542 are connected to the control components 524. The remote buttons 542 may include buttons configured to call one of the elevator cabs 510, 530. Additionally, the remote buttons 542 may include one or more switches for manually overriding the control systems and manually setting the renewable energy mode to on for at least one of the elevator control layouts.

FIG. 6 depicts a flow chart illustrating a sample process for mode selection during elevator operation in a system having multiple elevators, each having an associated renewable energy source, such as assembly 500 as discussed above. The process as shown in FIG. 6 may be performed by a control device or another similar computer processing device.

Similar to the process as shown in FIG. 3, the control system may determine 602 if there has been a car call demand. If the control system determines 602 there has been a car call demand, the control system may de-energize 604 the renewable energy contactor and check the auxiliary feedback contact.

The control system may also determine 606 if the auxiliary contact is open. If the control system determines the auxiliary contact is not open, the control system may generate 608 a fatal control fault. Alternatively, if the control system determines 606 the auxiliary feedback contact is open, the elevator control system may operate 610 in mode 1, i.e., standard elevator operation and software routines.

If the control system does not determine 602 there has been a car call demand, the control system may perform a series of additional system checks and determinations. For example, as shown in FIG. 6, the control system may: determine 612 if there has been a hall call demand; determine 614 if the elevator is operating in inspection mode; determine 616 if the elevator is operating in fire service mode; determine 618 if the elevator is operating another mode such as hospital emergency mode, independent operating mode, and other similar modes; and determine 620 if the elevator is operating on emergency power. If the control system determines 612, 614, 616, 618, 620 any of the conditions in the affirmative, the control system de-energizes 604 the renewable energy contactor as before.

In contrast, if the control system determines 612, 614, 616, 618, 620 all to be negative, the control system may check 622 the manual mode switch to determine 624 if the switch is on, indicating at least one of the elevator cabs is to operate in mode 2. If the control system determines 624 the switch is on, the control system signals the appropriate elevator cab(s) operate 626 in mode 2, i.e., regenerative power mode. If the control system determine 624 the switch is not on, the control system may check 628 the associated power meters for each renewable source associated with each elevator cab,. If the control system determines 630 there is no current demand for a specific elevator cab, the control system may determine 632 which cab(s) should operate in mode 1, i.e., maintain a ready state for passenger operation, and which cab(s) should operate in mode 2. For example, if the control system determines that the solar panel array is produce more power than the wind turbine (based upon a check 628 of the power meters), the control system may determine 632 that the elevator cab associated with the solar panel operate in mode 2, while the elevator cab associated with the wind turbine operate in mode 1.

Additional factors such as call timers may also impact the decision making process as used by the control system. For example, if a car call timer has exceeded a specific threshold, all cabs may be signaled to operate in mode 2. Then, when a call is received, the control system may determine which elevator cab to send based upon a similar process as that described in FIG. 6.

It should be noted the architecture and arrangement of components as shown in FIGS. 1, 2 and 5 are shown by way of example only to illustrate exemplary elevator control and motor drive systems. Depending on the design, construction and intended purpose of the systems, the type and arrangement of components may be altered. Similarly, the processes as shown in FIGS. 3, 4 and 6 are shown by way of example only and may be modified.

Additional software techniques may be integrated and incorporated into the systems and processes as described above as well. For example, weather data may be provided to a control system in order to provide the control system with additional information when choosing which elevator (and which associated renewable energy source) to switch from renewable energy collection to standard operation. For example, if weather information indicates it is to be sunny with little wind, an elevator associated with a solar panel array may be defaulted to run in regenerative power mode unless passenger need requires multiple cabs be running. Similarly, time data may be used to assist the control system in decision making. For example, at certain times of the day a solar array may be in the shade or the dark, and may produce little to no energy. During those times, the elevator associated with a wind turbine may be defaulted to run in regenerative power mode unless passenger need requires multiple cabs be running.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of running an elevator system in both passenger operation mode and a renewable energy mode, the method comprising:
determining, by an elevator control system, if a request has been received for an elevator cab to move to a specific location;
determining, by the elevator control system, if a request has been received to operate the elevator cab in a specific alternative mode if there are no requests for the elevator cab to move to a specific location;
signaling, by the elevator control system, a semiconductor switch to connect a renewable energy source to a regenerative motor drive if it is determined there are no requests received to operate the elevator cab in a specific alternative mode; and
absorbing, by the regenerative drive, regenerative power produced by the renewable power source until the elevator control system receives a request to enter passenger operation mode.

2. The method of claim 1, wherein the renewably energy source comprises at least one of a solar panel array and a wind turbine.

3. The method of claim 1, wherein determining if a request has been received for the elevator cab to move to a specific location comprises monitoring a car call demand signal for indication of a request.

4. The method of claim 1, wherein signaling the semiconductor comprises monitoring a fault contactor operably connected to the semiconductor in the event the semiconductor fails.

5. The method of claim 1, further comprising interrupting, by the control system, current flow between a power source and the regenerative motor drive when the regenerative motor drive is absorbing power from the renewable energy source.

6. The method of claim 1, wherein the regenerative drive is further configured to absorb regenerative power from a plurality of renewable energy sources.

7. A method of running an elevator system comprising a plurality of elevator cabs in both passenger operation mode and a renewable energy mode, the method comprising:
determining, by an elevator control system, if a request has been received for each of the plurality of elevator cabs to move to a specific location;
determining, by the elevator control system, if a request has been received to operate each of the plurality of elevator cabs in a specific alternative mode if there are no requests for the elevator cab to move to a specific location;
signaling, by the elevator control system, a semiconductor switch to connect a renewable energy source to a regenerative motor drive for each of the plurality of elevator cabs if it is determined there are no requests received to operate each of the plurality of elevator cabs in a specific alternative mode;
absorb, by each of the regenerative drives, regenerative power produced by the renewable power source until the elevator control system receives a request to enter passenger operation mode;
receiving, by the elevator control system, a request for at least one of the elevator cabs to move to a specific location; and
determining, by the elevator control system, which of the plurality of elevator cabs to move to the specific location and which to leave in regenerative mode.

8. The method of claim 7, wherein determining which of the plurality of elevator cabs to move to the specific location and which to leave in regenerative mode comprises:
determining, by the elevator control system, an amount of power being produced by each renewable energy source to identify the renewable energy source producing a lowest amount of power; and
changing operation of the elevator cab associated with the identified renewable energy source having the lowest amount of power to passenger operation mode.

9. The method of claim 7, wherein the renewably energy sources comprise at least one of a solar panel array and a wind turbine.

10. The method of claim 7, wherein determining if a request has been received for each of the plurality of elevator cabs to move to a specific location comprises monitoring a car call demand signal for indication of a request.

11. The method of claim 7, wherein signaling the semiconductor comprises monitoring a fault contactor operably connected to the semiconductor in the event the semiconductor fails.

12. The method of claim 7, further comprising interrupting, by the control system, current flow between a power source and the regenerative motor drive for each of the plurality of elevator cabs when the regenerative motor drive is absorbing power from the renewable energy source.
